(19) United States
(12) Patent Application Publication
(10) Pub. No.: US 2011/0298904 A1
(43) Pub. Date: Dec. 8, 2011

(54) IMAGE PROCESSING APPARATUS, IMAGE PROCESSING METHOD, AND IMAGE DISPLAY APPARATUS

(76) Inventors: Noritaka OKUDA, Tokyo (JP); Hirotaka Sakamoto, Tokyo (JP); Satoshi Yamanaka, Tokyo (JP); Toshiaki Kubo, Tokyo (JP); Jun Someya, Tokyo (JP)

(21) Appl. No.: 13/152,448

(22) Filed: Jun. 3, 2011

(30) Foreign Application Priority Data
Jun. 4, 2010 (JP) 2010-128995

(51) Int. Cl. H04N 13/04; G06T 15/00

(52) U.S. Cl. 348/51; 382/154; 348/E13.075

(57) ABSTRACT

The frame-parallax-adjustment-amount generating unit outputs, as first parallax data, parallax data of an image portion protruded most among image portions protruded more than a first reference value from a pair of frame images forming a three-dimensional image. The pixel-parallax-adjustment-amount generating unit outputs, as second parallax data, parallax data of an image portion retracted more than a second reference value from the pair of frame images. The adjusted-image generating unit generates a pair of image output data by moving the entire pair of image input data to the inner side based on the first parallax data and moving an image portion retracted more than the second reference value of the pair of image input data based on the second parallax data to adjust a parallax amount and outputs the pair of image output data.

### BACKGROUND OF THE INVENTION

1. Field of the Invention

The present invention generally relates to an image processing apparatus, an image processing method, and an image display apparatus.

2. Description of the Related Art

In recent years, as an image display technology for an viewer to simulatively obtain the sense of depth, there is a three-dimensional image display technology that makes use of the binocular parallax. In the three-dimensional image display technology that makes use of the binocular parallax, a video viewed by the left eye and a video viewed by the right eye in a three-dimensional space are separately shown to the left eye and the right eye of the viewer, whereby the viewer feels that the videos are three-dimensional.

As a technology for showing different videos to the left and right eyes of the viewer, there are various systems such as a system for temporally alternately switching an image for left eye and an image for right eye to display the images on a display and, at the same time, temporally separating the left and right fields of view using eyeglasses for controlling amounts of light respectively transmitted through the left and right lenses in synchronization with image switching timing; and a system for using, on the front surface of a display, a barrier or a lens for limiting a display angle of an image in order to show an image for left eye and an image for right eye respectively to the left and right eyes.

When a parallax is large in such a three-dimensional image display apparatus, a protrusion amount and a retraction amount increase and surprise can be given to the viewer. However, when the parallax is increased to be equal to or larger than a certain degree, images for the right eye and the left eye do not fuse because of a fusion limit, a double image is seen, and a three-dimensional view cannot be obtained.

As measures against this problem, Japanese Patent Application Laid-open No. 2010-45584 (paragraph 0037, FIG. 1) discloses a technology for correcting a dynamic range, which is the width of a depth amount represented by protrusion and retraction of a three-dimensional image, to make it easy for an viewer to obtain a three-dimensional view.

However, in the technology disclosed in Japanese Patent Application Laid-open No. 2010-45584 (paragraph 0037, FIG. 1), because the dynamic range is corrected, noise tends to occur. Specifically, when the dynamic range is compressed, a protruded image portion is corrected to move to the inner side and a retracted image portion is corrected to move to the front side. In this case, for example, in an image portion for the left eye, the protruded image portion moves to the left side on a display screen and the retracted image portion moves to the right side on the display screen. Because the image portion moving to the right side and the image portion moving to the left side are present on one screen, image portions present behind the moved image portions and not present in the original images appear. Therefore, image portions appearing anew are estimated from the original images and created anew. However, when this correction is insufficient, the image sections are displayed as noise.

### SUMMARY OF THE INVENTION

It is an object of the present invention to at least partially solve the problems in the conventional technology.

According to an aspect of the present invention, there is provided an image processing apparatus including: a frame-parallax-adjustment-amount generating unit that outputs, as first parallax data, parallax data of an image portion protruded most among image portions protruded more than a first reference value from a pair of image input data forming a three-dimensional image; a pixel-parallax-adjustment-amount generating unit that outputs, as second parallax data, parallax data of an image portion retracted more than a second reference value from the pair of input image data; and an adjusted-image generating unit that generates a pair of image output data by moving the entire pair of image input data to an inner side based on the first parallax data and moving the image portion retracted more than the second reference value of the pair of image input data to a front side based on the second parallax data to adjust a parallax amount and outputs the pair of image output data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a configuration of an image display apparatus according to a first embodiment of the present invention;

FIG. 2 is a diagram of a configuration of a frame-parallax-adjustment-amount generating unit of an image processing apparatus according to the first embodiment of the present invention;

FIG. 3 is a diagram of a configuration of a pixel-parallax-adjustment-amount generating unit of the image processing apparatus according to the first embodiment of the present invention;

FIG. 4 is a diagram explaining a method in which a parallax calculating unit of the image processing apparatus according to the first embodiment of the present invention calculates parallax data;

FIG. 5 is a diagram of a detailed configuration of the parallax calculating unit of the image processing apparatus according to the first embodiment of the present invention;

FIG. 6 is a diagram explaining a method in which a region-parallax calculating unit of the image processing apparatus according to the first embodiment of the present invention calculates parallax data;

FIG. 7 is a detailed diagram of parallax data input to a frame-parallax calculating unit of the image processing apparatus according to the first embodiment of the present invention;

FIG. 8 is a diagram explaining a method of calculating data of a frame parallax from parallax data of the image processing apparatus according to the first embodiment of the present invention;

FIG. 9 is a diagram explaining, in detail, frame parallax data after correction calculated from frame parallax data of the image processing apparatus according to the first embodiment of the present invention;

FIGS. 10A to 10D are diagrams explaining a change in a protrusion amount due to changes in a parallax amount of image input data and a parallax amount of image output data of the image display apparatus according to the first embodiment of the present invention;

FIG. 11 is a diagram explaining a change in a retraction amount due to changes in a parallax amount of image input data and a parallax amount of image output data of the image display apparatus according to the first embodiment of the present invention;

FIG. 12 is a diagram explaining an example of an adjusting operation for a parallax amount according to the first embodiment of the present invention;

FIG. 13 is a flowchart explaining a flow of an image processing method for a three-dimensional image of an image processing apparatus according to a second embodiment of the present invention;

FIG. 14 is a flowchart explaining a flow of a frame parallax calculating step of the image processing apparatus according to the second embodiment of the present invention; and

FIG. 15 is a flowchart explaining a flow of a frame parallax correcting step of the image processing apparatus according to the second embodiment of the present invention.

### DETAILED DESCRIPTION OF THE PREFERRED EMBODIMENTS

### First Embodiment

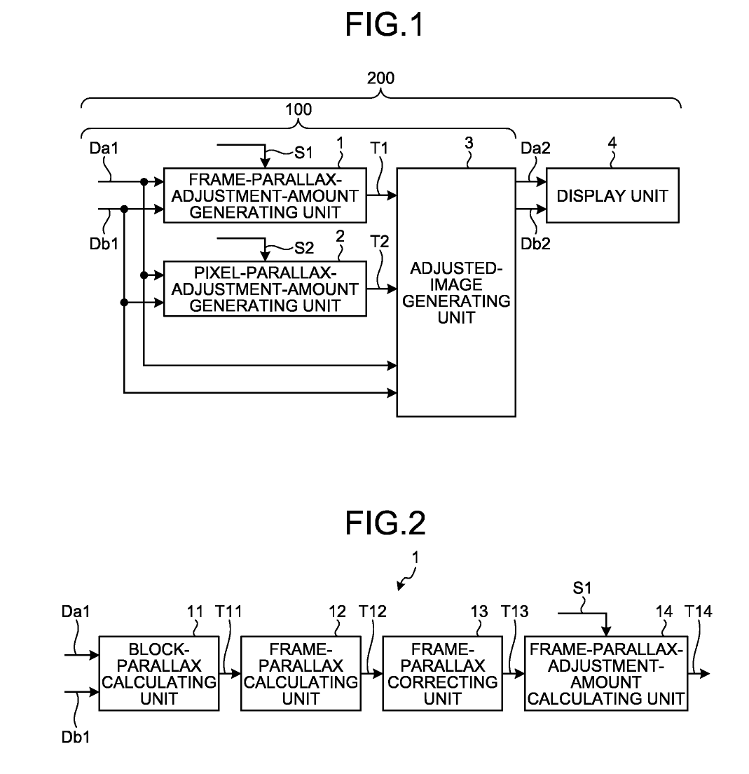

FIG. 1 is a diagram of the configuration of an image display apparatus 200 that displays a three-dimensional image according to a first embodiment of the present invention. The image display apparatus 200 according to the first embodiment includes a frame-parallax-adjustment-amount generating unit 1, a pixel-parallax-adjustment-amount generating unit 2, an adjusted-image generating unit 3, and a display unit 4. An image processing apparatus 100 in the image display apparatus 200 includes the frame-parallax-adjustment-amount generating unit 1, the pixel-parallax-adjustment-amount generating unit 2, and the adjusted-image generating unit 3.

Image input data for left eye Da1 and image input data for right eye Db1 are input to each of the frame-parallax-adjustment-amount generating unit 1, the pixel-parallax-adjustment-amount generating unit 2, and the adjusted-image generating unit 3. The frame-parallax-adjustment-amount generating unit 1 generates, based on the image input data for left eye Da1 and the image input data for right eye Db1, frame parallax data T1, which is first parallax data, and outputs the frame parallax data T1 to the adjusted-image generating unit 3. The pixel-parallax-adjustment-amount generating unit 2 generates, based on the image input data for left eye Da1 and the image input data for right eye Db1, pixel parallax data T2, which is second parallax data, and outputs the pixel parallax data T2 to the adjusted-image generating unit 3.

The adjusted-image generating unit 3 outputs image output data for left eye Da2 and image output data for right eye Db2 obtained by adjusting, based on the frame parallax data T1 and the pixel parallax data T2, a pixel parallax and a frame parallax between the image input data for left eye Da1 and the image input data for right eye Db1. The image output data for left eye Da2 and the image output data for right eye Db2 are input to the display unit 4. The display unit 4 displays the image output data for left eye Da2 and the image output data for right eye Db2 on a display surface.

FIG. 2 is a diagram of the configuration of the frame-parallax-adjustment-amount generating unit 1. The frame-parallax-adjustment-amount generating unit 1 according to the first embodiment includes a block-parallax calculating unit 11, a frame-parallax calculating unit 12, a frame-parallax correcting unit 13, and a frame-parallax-adjustment-amount calculating unit 14.

The image input data for left eye Da1 and the image input data for right eye Db1 are input to the block-parallax calculating unit 11. The block-parallax calculating unit 11 calculates, based on the image input data for left eye Da1 and the image input data for right eye Db1, a parallax in each of regions and outputs block parallax data T11 to the frame-parallax calculating unit 12. The frame-parallax calculating unit 12 calculates, based on the block parallax data T11, a parallax with respect to a focused frame (hereinafter may be referred to as “frame of attention”) and outputs the parallax as frame parallax data T12. The frame parallax data T12 is input to the frame-parallax correcting unit 13.

The frame-parallax correcting unit 13 outputs frame parallax data after correction T13 obtained by correcting the frame parallax data T12 of the frame of attention with reference to the frame parallax data T12 of frames at other times. The frame parallax data after correction T13 is input to the frame-parallax-adjustment-amount calculating unit 14.

The frame-parallax-adjustment-amount calculating unit 14 outputs frame parallax adjustment data T14 calculated based on parallax adjustment information S1 input by an viewer 9 and the frame parallax data after correction T13. The frame parallax adjustment data T14 is input to the adjusted-image generating unit 3.

In the first embodiment, the frame-parallax-adjustment-amount generating unit 1 outputs the frame parallax adjustment data T14, which is obtained by processing the frame parallax data T12 in the frame-parallax correcting unit 13 and the frame-parallax-adjustment-amount calculating unit 14. Therefore, the frame parallax data T1, which is the first parallax data, is the frame parallax adjustment data T14 generated based on the parallax adjustment information S1. Alternatively, it is also possible to omit the processing in the frame-parallax correcting unit 13 and the frame-parallax-adjustment-amount calculating unit 14 and output the frame parallax data T12 as the frame parallax data T1. It is also possible to omit only the processing of the frame-parallax correcting unit 13 or to set the frame parallax adjustment data T14 to a prior setting value rather than inputting the parallax adjustment information S1 from the viewer 9.

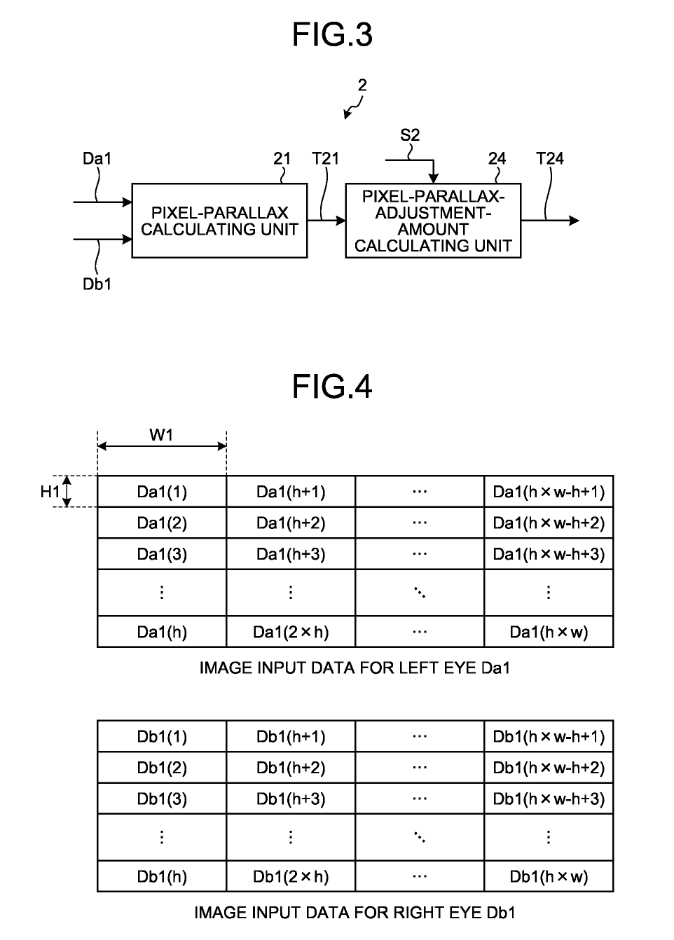

FIG. 3 is a diagram of the configuration of the pixel-parallax-adjustment-amount generating unit 2. The pixel-parallax-adjustment-amount generating unit 2 according to the first embodiment includes a pixel-parallax calculating unit 21 and a pixel-parallax-adjustment-amount calculating unit 24.

The image input data for left eye Da1 and the image input data for right eye Db1 are input to the pixel-parallax calculating unit 21. The pixel-parallax calculating unit 21 calculates, based on the image input data for left eye Da1 and the image input data for right eye Db1, a parallax in each of pixels and outputs pixel parallax data T21 to the pixel-parallax-adjustment-amount calculating unit 24.

The pixel-parallax-adjustment-amount calculating unit 24 outputs pixel parallax adjustment data T24 calculated based on parallax adjustment information S2 input by the viewer 9 and the pixel parallax data T21. The pixel parallax adjustment data T24 is input to the adjusted-image generating unit 3.

In the first embodiment, the pixel-parallax-adjustment-amount generating unit 2 outputs the pixel parallax adjustment data T24, which is processed by the pixel-parallax-adjustment-amount calculating unit 24 based on the pixel parallax data T21 and the parallax adjustment information S1. Therefore, the pixel parallax data T2, which is the second parallax data, is the pixel parallax adjustment data T24 generated based on the parallax adjustment information S2. Alternatively, it is also possible to omit the processing in the pixel-parallax-adjustment-amount calculating unit 24 and output the pixel parallax data T21 as the pixel parallax data T2. It is also possible to set the pixel parallax adjustment data T24 to a prior setting value rather than inputting the parallax adjustment information S2 from the viewer 9. Before the pixel-parallax-adjustment-amount calculating unit 24, as in the frame-parallax correcting unit 13, it is also possible to output, as the pixel parallax data T2, pixel parallax data after correction T23 obtained by correcting the pixel parallax data T21 of a frame of attention with reference to the pixel parallax data T21 of frames in other times.

The adjusted-image generating unit 3 outputs the image output data for left eye Da2 and the image output data for right eye Db2 obtained by adjusting, based on the frame parallax adjustment data T14 and the pixel parallax adjustment data T24, a parallax between the image input data for left eye Da1 and the image input data for right eye Db1. The image output data for left eye Da2 and the image output data for right eye Db2 are input to the display unit 4. The display unit 4 displays the image output data for left eye Da2 and the image output data for right eye Db2 on the display surface.

As explained above, the frame-parallax-adjustment-amount generating unit 1 outputs frame parallax data T1 for each of frames. In the first embodiment, the frame parallax data T1 is the frame parallax adjustment data T14. The frame parallax adjustment data T14 is a parallax amount for reducing a protrusion amount according to image adjustment. Specifically, the frame-parallax-adjustment-amount generating unit 1 performs processing for calculating a parallax amount of an image portion protruded most in a frame and moving an image of the entire frame (a frame image) to the inner side by a fixed amount. To move the image of the entire frame (the frame image) to the inner side by the fixed amount, the entire image input data for left eye Da1 is moved to the left side on a screen and the entire image input data for right eye Db1 is moved to the right side on the screen. The processing has an effect that the processing is simple compared with a method of determining a movement amount for each of pixels and adjusting an image, and occurrence of noise involved in the processing can be suppressed.

On the other hand, the pixel-parallax-adjustment-amount generating unit 2 outputs the parallax data T2 of a target image portion in the frame. In the first embodiment, the image portion parallax data T2 is the pixel parallax adjustment data T24. The pixel parallax adjustment data T24 is a parallax amount for reducing a retraction amount of the target image portion according to image adjustment. Specifically, the pixel-parallax-adjustment-amount generating unit 2 performs processing for moving pixels in a portion having a large retraction amount in the frame to the front side by a fixed amount. Incidentally, the frame image is an image of the entire frame. Furthermore, the image portion is an image of a portion of the frame image including an image in pixel unit. The image includes the frame image as well as the image portion.

The viewer 9 less easily obtains a three-dimensional view either when a three-dimensional image is excessively protruded or when the three-dimensional image is excessively retracted. When an image portion protruded most is moved to the inner side to a proper range by the frame-parallax-adjustment-amount generating unit 1, in some case, an image portion on the inner side is forced out further to the inner side than the proper range. The pixel-parallax-adjustment-amount generating unit 2 performs work for moving the image portion present further on the inner side than the proper range to the front side for each of target image portions rather than for the entire frame and fitting the image in the proper range. Consequently, the entire image is fit in a range of a proper depth amount.

As explained above, the method of adjusting a parallax amount for each of pixels has a disadvantage that noise tends to occur. When an image portion is moved to the left and right on the screen, an image portion present on the rear side of the image portion appears. However, because the appeared image portion is originally not present, the image is estimated from images around the image and complemented. When the image is complemented, noise is caused by incomplete complementation. However, usually, a target image portion itself of the image on the inner side is small and the image portion on the inner side is unclear compared with an image portion protruded and displayed near the viewer 9. Therefore, there is an advantage that it is possible to suppress occurrence of noise involved in the adjustment of a parallax amount for each of pixels.

The detailed operations of the image processing apparatus 100 according to the first embodiment of the present invention are explained below.

FIG. 4 is a diagram for explaining a method in which the block-parallax calculating unit 11 calculates, based on the image input data for left eye Da1 and the image input data for right eye Db1, the block parallax data T11.

The block-parallax calculating unit 11 divides the image input data for left eye Da1 and the image input data for right eye Db1, which are input data, such that each divided data corresponds to the size of regions sectioned in width W1 and height H1 on a display surface 61 and calculates a parallax in each of the regions. A three-dimensional video is a moving image formed by continuous pairs of images for left eye and images for right eye (frame images). The image input data for left eye Da1 is an image for left eye and the image input data for right eye Db1 is an image for right eye. Therefore, the images themselves of the video are the image input data for left eye Da1 and the image input data for right eye Db1. For example, when the invention according to the first embodiment is applied to a television, a decoder decodes a broadcast signal. A video signal obtained by the decoding is input as the image input data for left eye Da1 and the image input data for right eye Db1. The number of divisions of a screen is determined, when the invention according to the first embodiment is implemented in an actual LSI or the like, taking into account a processing amount or the like of the LSI.

The number of regions in the vertical direction of the regions sectioned on the display surface 61 is represented as a positive integer h and the number of regions in the horizontal direction is represented as a positive integer w. In FIG. 4, a number of a region at the most upper left is 1 and subsequent regions are numbered 2 and 3 to (h×w) from up to down in the left column and from the left column to the right column. Image data included in the first region of the image input data for left eye Da1 is represented as Da1(1) and image data included in the subsequent regions are represented as Db1(2) and Da1(3) to Da1(h×w). Similarly, image data included in the regions of the image input data for right eye Db1 are represented as Db1(1), Db1(2), and Db1(3) to Db(h×w)

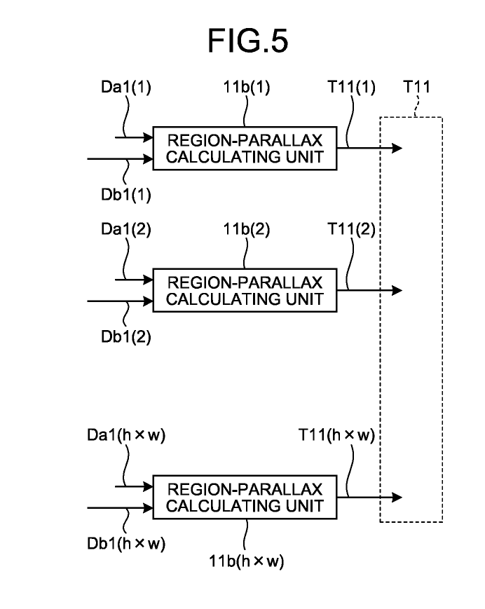

FIG. 5 is a diagram of the detailed configuration of the block-parallax calculating unit 11. The block-parallax calculating unit 11 includes h×w region-parallax calculating units to calculate a parallax in each of the regions. The region-parallax calculating unit 11b(1) calculates, based on the image input data for left eye Da1(1) and the image input data Db1(1) included in the first region, a parallax in the first region and outputs the parallax as parallax data T11(1) of the first region. Similarly, the region-parallax calculating units 11b(2) to 11b(h×w) respectively calculate parallaxes in the second to h×w-th regions, and output the parallaxes as parallax data T11(1) to T11(h×w) of the second to h×w-th regions. The block-parallax calculating unit 11 outputs the parallax data T11(1) to T11(h×w) of the first to h×w-th regions as the block parallax data T11.

The region-parallax calculating unit 11b(1) calculates, using a Phase-only correlation, region parallax data T11(1) of the image input data for left eye Da1(1) and the image input data for right eye Db1(1). The Phase-only correlation is explained in, for example, Non-Patent Literature (Mizuki Hagiwara and Masayuki Kawamata “Detection of Subpixel Displacement for Images Using Phase-Only Correlation”, the Institute of Electronics, Information and Communication Engineers Technical Report, No. CAS2001-11, VLD2001-28, DSP2001-30, June 2001, pp. 79 to 86). The Phase-only correlation is an algorithm for receiving a pair of images of a three-dimensional video as an input and outputting a parallax amount.

The following Formula (1) is a formula representing a parallax amount Nₒₚₜ calculated by the Phase-only correlation. In Formula (1), G_{ab}(n) represents a phase limiting correlation function.

Nₒₚₜ=argmax(G_{ab}(n)) (1)

where, n:0≦n≦W1 and argmax(G_{ab}(n)) is a value of n at which G_{ab}(n) is the maximum. When G_{ab}(n) is the maximum, n is Nₒₚₜ. G_{ab}(n) is represented by the following Formula (2):

$${G}_{ab} ( n ) = I F F T ( \frac{{F}_{ab} ( n )}{\vert {F}_{ab} ( n ) \vert} ) \qquad ( 2 )$$

where, a function IFFT is an inverse fast Fourier transform function and |F_{ab}(n)| is the magnitude of F_{ab}(n). F_{ab}(n) is represented by the following Formula (3):

F_{ab}(n)=A·B*(n) (3)

where, B*(n) represents a sequence of a complex conjugate of B(n), and A·B*(n) represents a convolution of A and B*(n). A and B(n) are represented by the following Formula (4):

A=FFT(a(m)), B(n)=FFT(b(m−n)) (4)

where, a function FFT is a fast Fourier transform function, a(m) and b(m) represent continuous one-dimensional sequences, m represents an index of a sequence, b(m)=a(m−τ), i.e., b(m) is a sequence obtained by shifting a(m) to the right by τ, and b(m−n) is a sequence obtained by shifting b(m) to the right by n.

In the region-parallax calculating unit lib, Nₒₚₜ calculated by the Phase-only correlation with the image input data for left eye Da1(1) set as “a” of Formula (4) and the image input data for right eye Db1(1) set as “b” of Formula (4) is the region parallax data T11(1).

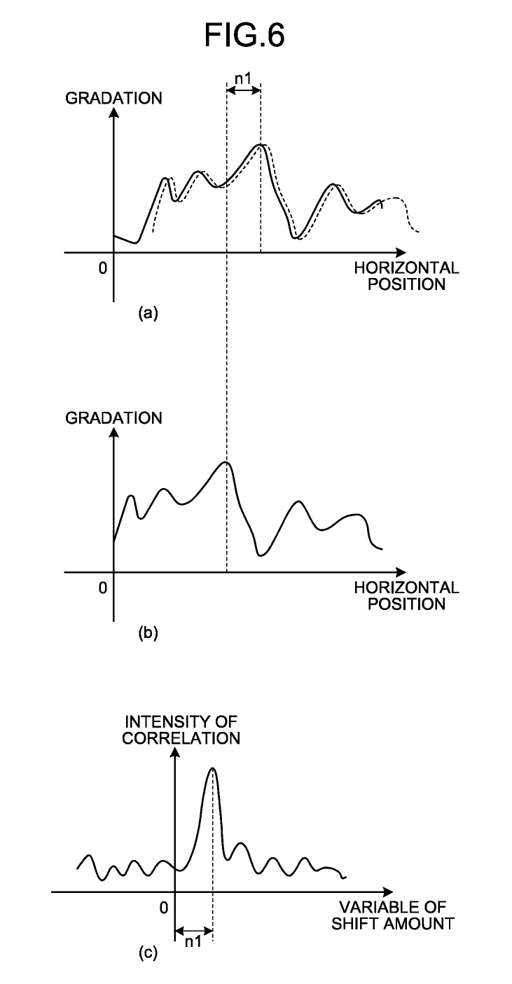

FIG. 6 is a diagram for explaining a method of calculating the region parallax data T11(1) from the image input data for left eye Da1(1) and the image input data for right eye Db1(1) included in the first region using the Phase-only correlation. A graph represented by a solid line in (a) of FIG. 6 is the image input data for left eye Da1(1) corresponding to the first region. The abscissa indicates a horizontal position and the ordinate indicates a gradation. A graph of (b) of FIG. 6 is the image input data for right eye Db1(1) corresponding to the first region. The abscissa indicates a horizontal position and the ordinate indicates a gradation. A graph represented by a broken line in (a) of FIG. 6 is the image input data for right eye Db1(1) shifted by a parallax amount n1 of the first region. A graph of (c) of FIG. 6 is the phase limiting correlation function G_{ab}(n). The abscissa indicates a variable n of G_{ab}(n) and the ordinate indicates the intensity of correlation.

The phase limiting correlation function G_{ab}(n) is defined by a sequence “a” and a sequence “b” obtained by shifting “a” by τ, which are continuous sequences. The phase limiting correlation function G_{ab}(n) is a delta function having a peak at n=−τ according to Formulas (2) and (3). When the image input data for right eye Db1(1) protrudes with respect to the image input data for left eye Da1(1), the image input data for right eye Db1(1) shifts in the left direction. When the image input data for right eye Db1(1) retracts with respect to the image input data for left eye Da1(1), the image input data for right eye Db1(1) shifts in the right direction. Data obtained by dividing the image input data for left eye Da1(1) and the image input data for right eye Db1(1) into regions is highly likely to shift in either the protruding direction or the retracting direction. Nₒₚₜ of Formula (1) calculated with the image input data for left eye Da1(1) and the image input data for right eye Db1(1) set as the inputs a(m) and b(m) of Formula (4) is the region parallax data T11(1).

A shift amount is n1 according to a relation between (a) and (b) of FIG. 6. Therefore, when the variable n of a shift amount concerning the phase limiting correlation function G_{ab}(n) is n1 as shown in (c) of FIG. 6, a value of a correlation function is the largest.

The region-parallax calculating unit 11b(1) outputs, as the region parallax data T11(1), the shift amount n1 at which a value of the phase limiting correlation function G_{ab}(n) with respect to the image input data for left eye Da1(1) and the image input data for right eye Db1(1) is the maximum according to Formula (1).

Similarly, the region-parallax calculating units 11b(2) to 11b(h×w) output, as the region parallax data T11(2) to T11(h×w), shift amounts at which values of phase limiting correlations with respect to the image input data for left eye Da1(2) to Da1(h×w) and the image input data for right eye Db1(2) to Db1(h×w) included in the second to h×w-th regions are respectively the peaks.

The non-Patent Literature (Mizuki Hagiwara and Masayuki Kawamata “Detection of Subpixel Displacement for Images Using Phase-Only Correlation”, the Institute of Electronics, Information and Communication Engineers Technical Report, No. CAS2001-11, VLD2001-28, DSP2001-30, June 2001, pp. 79 to 86) describes a method of directly receiving the image input data for left eye Da1 and the image input data for right eye Db1 as inputs and obtaining a parallax between the image input data for left eye Da1 and the image input data for right eye Db1. However, as an input image is larger, computational complexity increases. When the method is implemented in an LSI, a circuit size is large. Further, the peak of the phase limiting correlation function G_{ab}(n) with respect to an object captured small in the image input data for left eye Da1 and the image input data for right eye Db1 is small. Therefore, it is difficult to calculate a parallax of the object captured small.

The block-parallax calculating unit 11 according to the first embodiment divides the image input data for left eye Da1 and the image input data for right eye Db1 into small regions and applies the Phase-only correlation to each of the regions. Therefore, the Phase-only correlation can be implemented in an LSI in a small circuit size. In this case, the circuit size can be further reduced by calculating parallaxes for the respective regions in order using one circuit rather than simultaneously calculating parallaxes for all the regions. In the divided small regions, the object captured small in the image input data for left eye Da1 and the image input data for right eye Db1 occupies a relatively large region. Therefore, the peak of the phase limiting correlation function G_{ab}(n) is large and can be easily detected. Therefore, a parallax can be calculated more accurately. The frame-parallax calculating unit 12 explained below outputs, based on the parallaxes calculated for the respective regions, a parallax in the entire image between the image input data for left eye Da1 and the image input data for right eye Db1.

The detailed operations of the frame-parallax calculating unit 12 are explained below.

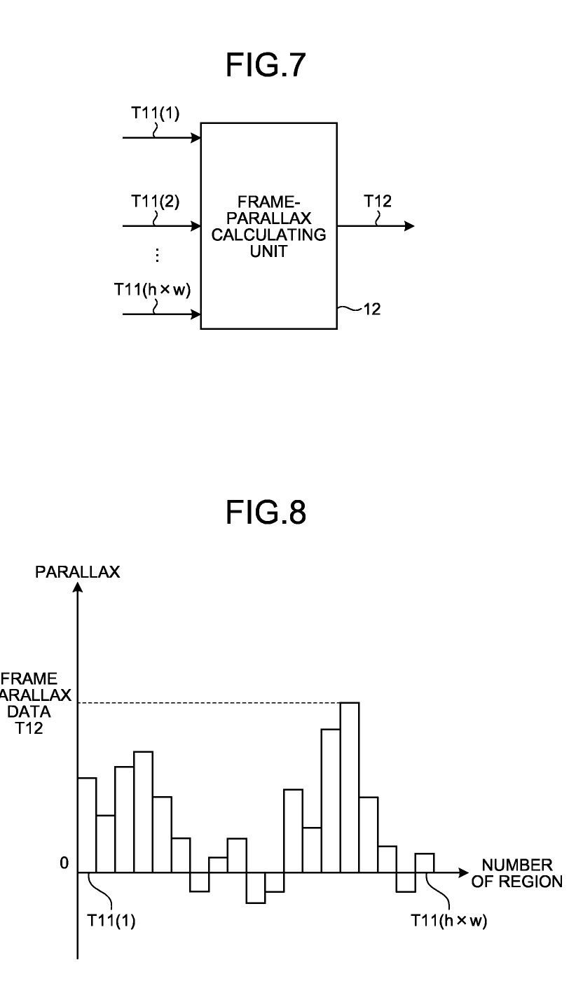

FIG. 7 is a detailed diagram of the block parallax data T11 input to the frame-parallax calculating unit 12. The frame-parallax calculating unit 12 aggregates the input region parallax data T11(1) to T11(h×w) corresponding to the first to h×w-th regions and calculates frame parallax data T12 with respect to an image of a frame of attention (a frame image).

FIG. 8 is a diagram for explaining a method of calculating, based on the region parallax data T11(1) to T(h×w), the frame parallax data T12. The abscissa indicates a number of a region and the ordinate indicates parallax data. The frame-parallax calculating unit 12 outputs maximum parallax data among the region parallax data T11(1) to T11(h×w) as the frame parallax data T12 of a frame image.

Consequently, concerning a three-dimensional video not embedded with parallax information, it is possible to calculate a parallax amount in a section protruded most in frames of the three-dimensional video considered to have the largest influence on the viewer 9.

The detailed operations of the frame-parallax correcting unit 13 are explained below.

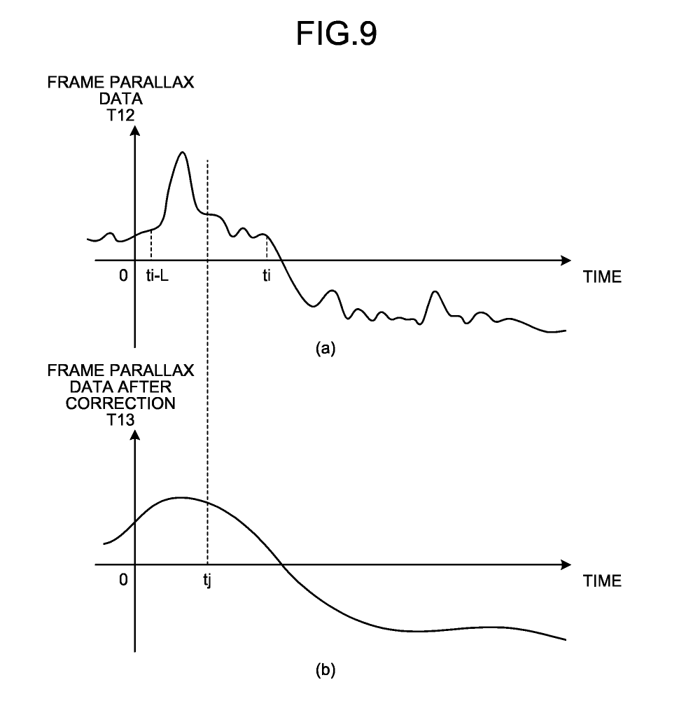

FIG. 9 is a diagram for explaining in detail the frame parallax data after correction T13 calculated from the frame parallax data T12. (a) of FIG. 9 is a diagram of a temporal change of the frame parallax data T12. The abscissa indicates time and the ordinate indicates the frame parallax data T12. (b) of FIG. 9 is a diagram of a temporal change of the frame parallax data after correction T13. The abscissa indicates time and the ordinate indicates the frame parallax data after correction T13.

The frame-parallax correcting unit 13 stores the frame parallax data T12 for a fixed time, calculates an average of frame parallax data T12 for previous and subsequent frames of a frame of attention, and outputs the average as the frame parallax data after correction T13.

$$T 13 ( tj ) = \frac{{\sum }_{k = ti - L}^{ti} T 12 ( k )}{L} \qquad ( 5 )$$

where, T13(tj) represents frame parallax data after correction at time tj of attention, T12(k) represents frame parallax data at time k, and a positive integer L represents width for calculating an average. Because ti<tj, for example, the frame parallax data after correction T13 at the time tj shown in (b) of FIG. 9 is calculated from an average of the frame parallax data T12 from time (ti-L) to time ti shown in (a) of FIG. 9.

Most 3D protrusion amounts temporally continuously change. When the frame parallax data T12 temporally discontinuously changes, for example, when the frame parallax data T12 changes in an impulse shape with respect to a time axis, it can be regarded that misdetection of the frame parallax data T12 occurs. The frame-parallax correcting unit 13 can temporally average the frame parallax data T12 even if there is the change in the impulse shape and can ease the misdetection by temporally averaging the frame parallax data T12.

The detailed operations of the frame-parallax-adjustment-amount calculating unit 14 are explained below.

The frame-parallax-adjustment-amount calculating unit 14 calculates, based on the parallax adjustment information S1 set by the viewer 9 to easily obtain a three-dimensional view and the frame parallax data after correction T13, a parallax adjustment amount and outputs the frame parallax adjustment data T14.

The parallax adjustment information S1 includes a parallax adjustment coefficient S1a and a parallax adjustment threshold S1b. The frame parallax adjustment data T14 is calculated from the frame parallax data after correction T13 according to Formula 4. The frame parallax adjustment data T14 is represented by the following Formula (6):

$$T 14 = \{ \begin{matrix}0 & ( T 13 \leq S 1 b ) \\ S 1 a \times ( T 13 - S 1 b ) & ( T 13 > S 1 b )\end{matrix} \qquad ( 6 )$$

The frame parallax adjustment data T14 means a parallax amount for reducing a protrusion amount according to image adjustment. The frame parallax adjustment data T14 indicates amounts for horizontally shifting the image input data for left eye Da1 and the image input data for right eye Db1. As explained in detail later, a sum of the amounts for horizontally shifting the image input data for left eye Da1 and the image input data for right eye Db1 is the frame parallax adjustment data T14. Therefore, when the frame parallax data after correction T13 is equal to or smaller than the parallax adjustment threshold S1b, the image input data for left eye Da1 and the image input data for right eye Db1 are not shifted in the horizontal direction according to the image adjustment. On the other hand, when the frame parallax data after correction T13 is larger than the parallax adjustment threshold S1b, the image input data for left eye Da1 and the image input data for right eye Db1 are shifted in the horizontal direction by a value obtained by multiplying the parallax adjustment coefficient S1a with a difference between the frame parallax data after correction T13 and the parallax adjustment threshold S1b.

For example, in the case of the parallax adjustment coefficient S1a=1 and the parallax adjustment threshold S1b=0, T14=0 when T13≦0. In other words, the image adjustment is not performed. On the other hand, T14=T13 when T13>0. The image input data for left eye Da1 and the image input data for right eye Db1 are shifted in the horizontal direction by T13. Because the frame parallax data after correction T13 is a maximum parallax of a frame image, a maximum parallax calculated in a frame of attention becomes 0. When the parallax adjustment coefficient S1a is reduced to be smaller than 1, the frame parallax adjustment data T14 decreases to be smaller than the frame parallax data after correction T13 and the maximum parallax calculated in the frame of attention increases to be larger than 0. When the parallax adjustment threshold S1b is increased to be larger than 0, adjustment of parallax data is not applied to the frame parallax data after correction T13 having a value larger than 0. In other words, parallax adjustment is not applied to a frame in which an image portion is slightly protruded.

In the above explanation, the block-parallax calculating unit 11 calculates a parallax in each of regions. However, the pixel-parallax calculating unit 21 calculates a parallax in each of pixels. As a calculation method, it is also possible that the divided regions adopted by the block-parallax calculating unit 11 are divided into smaller regions and a parallax in a divided minute region is set as a pixel parallax amount included in the region or, as in the block-parallax calculating unit 11, after a parallax in a region having a fixed size is calculated, the same point is detected in each of pixels included in the region and a pixel parallax amount of each of pixels is calculated and set as the pixel parallax data T21. It is also possible that, after regions having a high correlation are searched by block matching between the divided image input data for left eye Da1 and the divided image input data for right eye Db1, the pixel parallax data T21 as a parallax amount of each of pixels included in the regions is calculated.

The detailed operations of the pixel-parallax-adjustment-amount calculating unit 24 are explained below.

The pixel-parallax-adjustment-amount calculating unit 24 calculates the pixel parallax adjustment data T24 for adjusting a retraction amount to the inner side of a solid body of a three-dimensional image. The pixel-parallax-adjustment-amount calculating unit 24 calculates, based on the parallax adjustment information S2 set by the viewer 9 to easily obtain a three-dimensional view and the pixel parallax data T21, a parallax adjustment amount and outputs the pixel parallax adjustment data T24.

The parallax adjustment information S2 includes a parallax adjustment coefficient S2a and a parallax adjustment threshold S2b. The pixel parallax adjustment data T24 is represented by the following Formula (7):

$$T 24 = \{ \begin{matrix}0 & ( T 21 \geq S 2 b ) \\ S 2 a \times ( T 21 - S 2 b ) & ( T 21 < S 2 b )\end{matrix} \qquad ( 7 )$$

The pixel parallax adjustment data T24 means a parallax amount for reducing a retraction amount according to image adjustment. The pixel parallax adjustment data T24 indicates horizontal shift amounts of a pair of pixels of a three-dimensional video of the image input data for left eye Da1 and the image input data for right eye Db1. As explained in detail later, a sum of amounts for horizontally shifting the image input data for left eye Da1 and the image input data for right eye Db1 is T24. Therefore, when the pixel parallax data T21 is equal to or larger than the parallax adjustment threshold S2b, pixel data of the image input data for left eye Da1 and the image input data for right eye Db1 are not shifted in the horizontal direction according to the image adjustment. On the other hand, when the pixel parallax data T21 is smaller than the parallax adjustment threshold S2b, pixels of the image input data for left eye Da1 and the image input data for right eye Db1 are shifted in the horizontal direction by, as a total shift amount, a value obtained by multiplying the parallax adjustment coefficient S2a with a value of a difference between the pixel parallax data T21 and the parallax adjustment threshold S2b.

For example, in the case of the parallax adjustment coefficient S2a=0.5 and the parallax adjustment threshold S2b=0, T24=0 when T21≧0. In other words, the image adjustment is not performed. On the other hand, T24=T21×0.5 when T21<0. Each of the image input data for left eye Da1 and the image input data for right eye Db1 is shifted in the horizontal direction by a half amount of T21×0.5. A parallax amount as a whole is halved. In the case of the pixel parallax data T21<0, pixels corresponding to the pixel parallax data T21 are a three-dimensional image on a retraction side further on the inner side than a display position. Therefore, the retraction amount to the inner side decreases. When the parallax adjustment threshold S2b is reduced to be smaller than 0, a parallax only in a section displayed further in the inner part than the display position decreases. When the parallax adjustment threshold S2b is increased to be larger than 0, a parallax amount of a section displayed further in the front than the display position also decreases.

For example, a user determines the setting of the parallax adjustment information S1 and S2 while changing the parallax adjustment information S1 and S2 with input means such as a remote controller and checking at a change in a protrusion amount of the three-dimensional image. The user can also input the parallax adjustment information S1 and S2 from a parallax adjustment coefficient button and a parallax adjustment threshold button of the remote controller. Alternatively, predetermined parallax adjustment coefficients S1a and S2a and parallax adjustment thresholds S1b and S2b can be set when the user inputs an adjustment degree of a parallax from one ranked parallax adjustment button.

Furthermore, when the image display apparatus 200 includes a camera for observing the viewer 9, the parallax adjustment information S1 can be automatically set by determining the age and/or the sex of the viewer 9, and the distance from the display surface to the viewer 9, for example. In this case, the size of the display surface of the image display apparatus 200, or the like, can be included in the parallax adjustment information S1. Also, only a predetermined value, for example, the size of the display surface of the image display apparatus 200 can be used as the parallax adjustment information S1. Information such as personal information input by the viewer 9 with an input means like remote, the age and/or the sex of the viewer 9, an positional relation including the distance from the display surface to the viewer 9, and the size of the display surface of the image display apparatus 200, which are information concerning a state of viewing, is called information indicating a state of viewing.

Consequently, according to this embodiment, it is possible to change a parallax of an input pair of images (a frame image) to a parallax of a suitable sense of depth corresponding to a distance between the viewer 9 and the display surface 61, the size of the display surface 61, and an individual difference such as the preference of the viewer 9 or a range in which a three-dimensional view can be easily obtained and display a three-dimensional image.

The operation of the adjusted-image generating unit 3 is explained below.

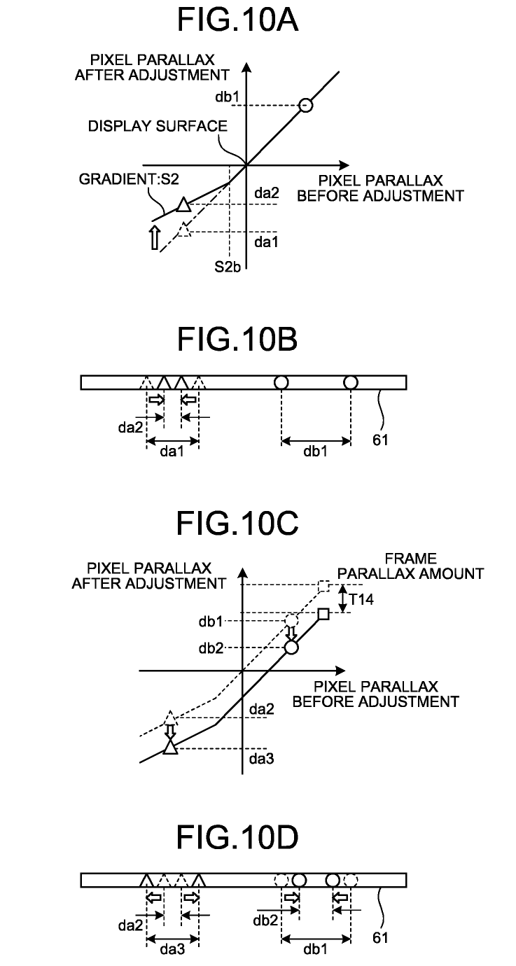

FIGS. 10A to 10D are diagrams explaining an image adjusting operation in the adjusted-image generating unit 3. First, the adjusted-image generating unit 3 horizontally shifts, based on the pixel parallax adjustment data T24 output from the pixel-parallax-adjustment-amount generating unit 2, a pair of pixels of a three-dimensional video of the image input data for left eye Da1 and the image input data for right eye Db1. FIG. 10A is a diagram explaining a first image adjusting operation based on the pixel parallax adjustment data T24 in the adjusted-image generating unit 3. The abscissa indicates a pixel parallax before adjustment and the ordinate indicates a pixel parallax after adjustment. As indicated by Formula (7), a parallax amount is adjusted when the pixel parallax data T21 is smaller than the threshold S2b. In FIG. 10A, a parallax amount of the display surface 61 is displayed as 0, protrusion further to the front side, which is the viewer 9 side, than the display surface 61 is displayed as a positive parallax amount, and retraction further to the inner side than the display surface 61 is displayed as a negative parallax amount. In other words, reducing a retraction amount to the inner side of the display surface 61 is equivalent to bringing the negative parallax amount close to 0.

An adjusting operation on the display surface 61 for circles displayed further in the front than the display surface 61 and triangles displayed further on the inner part than the display surface 61 is explained with reference to FIG. 10B. A parallax amount before adjustment between the triangles indicated by broken lines is represented as da1 (a negative value) and a parallax amount between the circles is represented as db1 (a positive value). Specifically, the triangle on the left side of the two triangles indicated by broken lines corresponds to the image input data for left eye Da1 and the triangle on the right side corresponds to the image input data for right eye Db1. The circle on the left side of the two circles corresponds to the image input data for right eye Da1 and the circle on the right side corresponds to the image input data for left eye Da1. When da1<S2b and db1>S2b, da1 is adjusted to da1 based on Formula 7 and db1 does not change. This adjusting operation is carried out according to a parallax amount of each of pixels.

Subsequently, the adjusted-image generating unit 3 carries out, based on the frame parallax adjustment data T14 output by the frame-parallax-adjustment-amount generating unit 1, a second image adjusting operation.

FIG. 10C is a diagram explaining the second image adjusting operation based on the frame parallax adjustment data T14 in the adjusted-image generating unit 3. The abscissa indicates a pixel parallax before adjustment and the ordinate indicates a pixel parallax after adjustment. As indicated by Formula (6), a parallax amount is adjusted when the frame parallax adjustment data T14 indicated by a square in FIG. 10C is larger than the threshold S1b. As shown in FIG. 10C, a parallax amount of all pixels is adjusted such that an entire three-dimensional image moves to the inner part. The parallax amount db1 of the circle indicated by the broken line shown in FIG. 10B is adjusted to a parallax amount db2 of a circle indicated by a solid line. The parallax amount da2 of the triangle indicated by the broken line is adjusted to a parallax amount da3 of a triangle indicated by a solid line.

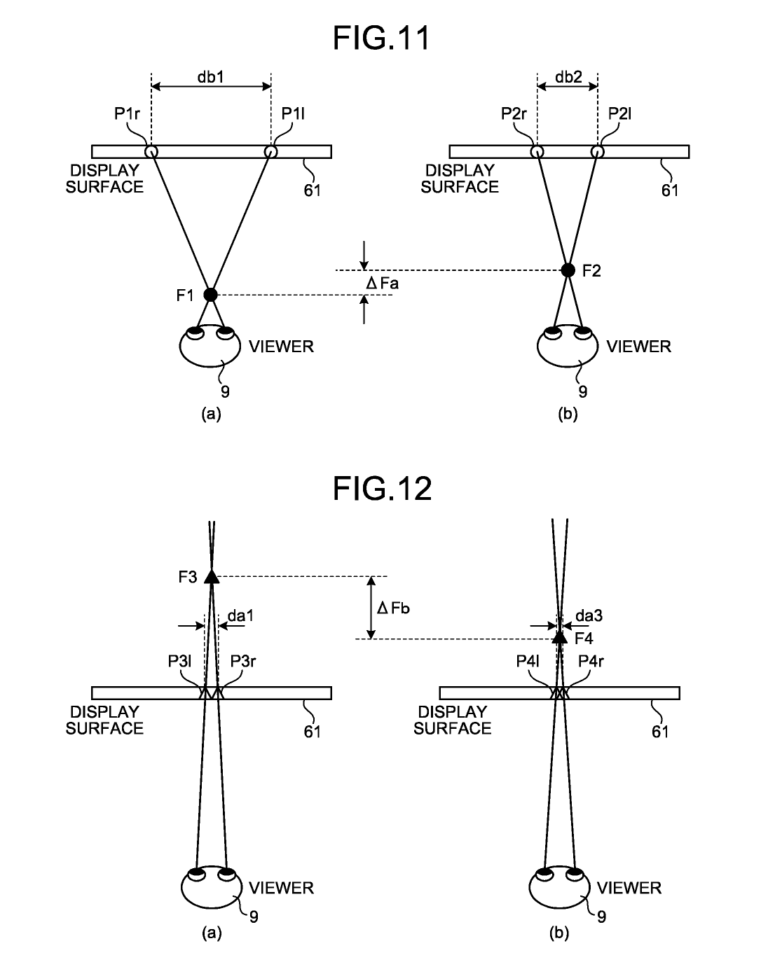

FIG. 11 is a diagram explaining a relation among a parallax between the image input data for left eye Da1 and the image input data for right eye Db1, a parallax between the image output data for left eye Da2 and the image output data for right eye Db2, and protrusion amounts of respective images. (a) of FIG. 11 is a diagram explaining a relation between the image input data for left eye Da1 and image input data for right eye Db1 and a protrusion amount of an image portion. (b) of FIG. 11 is a diagram explaining a relation between the image output data for left eye Da2 and image output data for right eye Db2 and a protrusion amount of an image portion.

When the adjusted-image generating unit 3 determines that T13>S1b, based on the frame parallax adjustment data T14, the adjusted-image generating unit 3 horizontally moves a pixel P11 of the image input data for left eye Da1 in the left direction and horizontally moves a pixel P1r of the image input data for right eye Db1 in the right direction. As a result, the adjusted-image generating unit 3 outputs a pixel P21 of the image output data for left eye Da1 and a pixel P2r of the image output data for right eye Db2. At this point, the parallax db2 is calculated by db2=db1−T14.

When the pixel P11 of the image input data for left eye Da1 and the pixel P1r of the image input data for right eye Db1 are assumed to be the same part of the same object, a parallax between the pixels P11 and P1r is db1 and, from the viewer 9, the object is seen to be protruded to a position F1.

When the pixel P21 of the image output data for left eye Da2 and the pixel P2r of the image output data for right eye Db2 are assumed to be the same part of the same object, a parallax between the pixels P21 and P2r is db2 and, from the viewer 9, the v seen to be protruded to a position F2.

The image input data for left eye Da1 is horizontally moved in the left direction and the image input data for right eye Db1 is horizontally moved in the right direction, whereby the parallax db1 decreases to the parallax db2. Therefore, the protruded position changes from F1 to F2 with respect to the decrease of the parallax.

The frame parallax data after correction T13 is calculated from the frame parallax data T12, which is the largest parallax data of a frame image. Therefore, the frame parallax data after correction T13 is the maximum parallax data of the frame image. The frame parallax adjustment data T14 is calculated based on the frame parallax data after correction T13 according to Formula (6). Therefore, when the parallax adjustment coefficient S1a is 1, the frame parallax adjustment data T14 is equal to the maximum parallax in a frame of attention. When the parallax adjustment coefficient S1a is smaller than 1, the frame parallax adjustment data T14 is smaller than the maximum parallax. When it is assumed that the parallax db1 shown in (a) of FIG. 11 is the maximum parallax calculated in the frame of attention, the maximum parallax db2 after adjustment shown in FIGS. 10C and 10D is a value smaller than db1 when the parallax adjustment coefficient S1a is set smaller than 1. When the parallax adjustment coefficient S1a is set to 1 and the parallax adjustment threshold S1b is set to 0, a video is an image portion that is not protruded and db2 is 0. Consequently, the maximum protruded position F2 of the image data after adjustment is adjusted to a position between the display surface 61 and the protruded position F1.

FIG. 12 is a diagram explaining a parallax between the image input data for left eye Da1 and the image input data for right eye Db1, a parallax between the image output data for left eye Da2 and the image output data for right eye Db2, and retraction amounts of respective image portions. (a) of FIG. 12 is a diagram explaining a relation between the image input data for left eye Da1 and image input data for right eye Db1 and a retraction amount of an image portion. (b) of FIG. 12 is a diagram explaining a relation between the image output data for left eye Da2 and the image output data for right eye Db2 and a retraction amount of an image portion.

When the adjusted-image generating unit 3 determines that T21<S2b and T13>S1b, as a first adjusting operation, based on the pixel parallax adjustment data T24, the adjusted-image generating unit 3 horizontally moves a target pixel of the image input data for left eye Da1 in the right direction and horizontally moves a target pixel of the image input data for right eye Db1 in the left direction. Thereafter, as a second adjusting operation, based on the frame parallax adjustment data T14, the adjusted-image generating unit 3 horizontally moves the image input data for left eye Da1 in the left direction and horizontally moves the image input data for right eye Db1 in the right direction. As a result, the adjusted-image generating unit 3 outputs the image output data for left eye Da2 and the image output data for right eye Db2. At this point, the parallax da3 is calculated by da3=da1−T24−T14.

When a pixel P3l of the image input data for left eye Da1 and a pixel P3r of the image input data for right eye Db1 are assumed to be the same part of the same object, a parallax between the pixels P3l and P3r is da1 and, from the viewer 9, the object is seen to be retracted to a position F3.

When a pixel P4l of the image output data for left eye Da2 and a pixel P4r of the image output data for right eye Db2 are assumed to be the same part of the same object, a parallax between the pixels P4l and P4r is da3 and, from the viewer 9, the object is seen to be retracted to a position F4.

The parallax da1 is adjusted to the parallax da3 according to the first and second image adjusting operation. Therefore, the retracted position changes from F3 to F4 with respect to the adjustment of the parallax. First, the adjusted-image generating unit 3 performs, based on the pixel parallax adjustment data T24, the first adjusting operation and then performs, based on the frame parallax adjustment data T14, the second adjusting operation. Alternatively, the order of the first and second adjusting operations is not limited to this order. The adjusted-image generating unit 3 can also perform the first adjusting operation after the performing the second adjusting operation.

The operation of the display unit 4 is explained below. The display unit 4 displays the image output data for left eye Da2 and the image output data for right eye Db2 separately to the left eye and the right eye of the viewer 9. Specifically, a display system can be a 3D display system employing a display that can display different images on the left eye and the right eye with an optical mechanism or can be a 3D display system employing dedicated eyeglasses that close shutters of lenses for the left eye and the right eye in synchronization with a display that alternately displays an image for left eye and an image for right eye.

The pixel-parallax-adjustment-amount generating unit 2 in the first embodiment includes the pixel-parallax calculating unit 21 and the pixel-parallax-adjustment-amount calculating unit 24. Alternatively, like the frame-parallax correcting unit 13, the pixel-parallax-adjustment-amount generating unit 2 can be configured to temporally average the pixel parallax data T21 output by the pixel-parallax calculating unit 21 and prevent misdetection.

### Second Embodiment

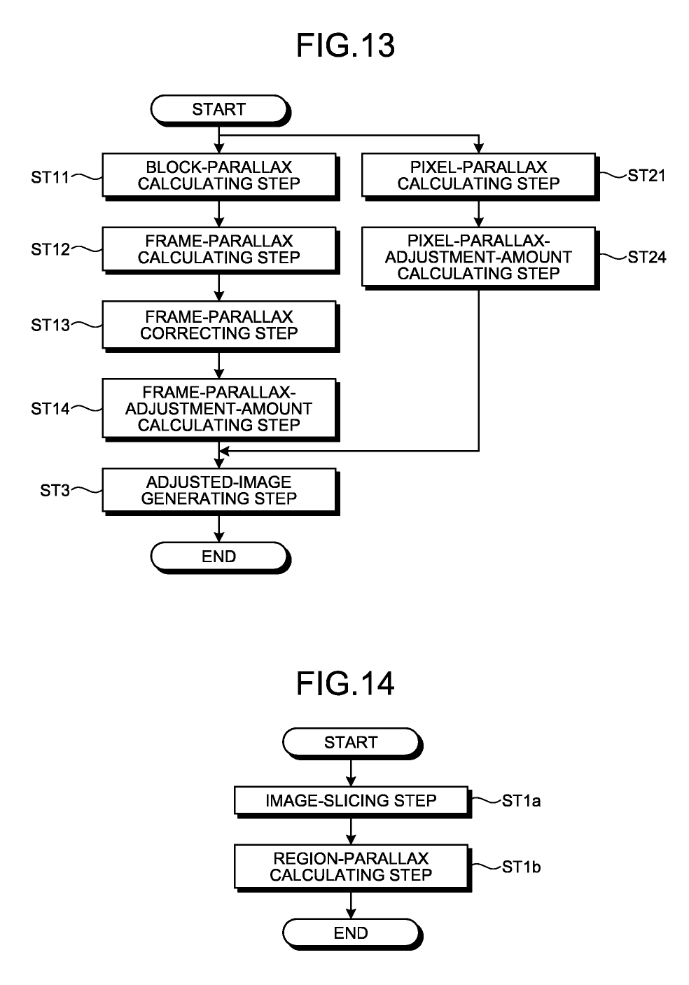

FIG. 13 is a flowchart explaining a flow of an image processing method for a three-dimensional image according to a second embodiment of the present invention. The three-dimensional-image processing method according to the second embodiment includes a block-parallax calculating step ST11, a frame-parallax calculating step ST12, a frame-parallax correcting step ST13, a frame-parallax-adjustment-amount calculating step ST14, a pixel-parallax calculating step ST21, and the pixel-parallax-adjustment-amount calculating step ST24.

The frame-parallax calculating step ST11 includes an image-slicing step ST1a and a region-parallax calculating step ST1b as shown in FIG. 14.

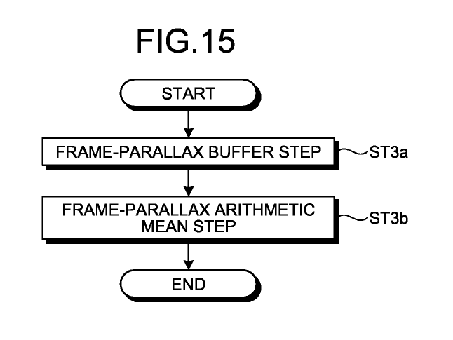

The frame-parallax correcting step ST13 includes a frame-parallax buffer step ST3a and a frame-parallax arithmetic mean step ST3b as shown in FIG. 15.

The operation in the second embodiment of the present invention is explained below.

First, at the block-parallax calculating step ST11, processing explained below is applied to the image input data for left eye Da1 and the image input data for right eye Db1.

At image-slicing step ST1a, the image input data for left eye Da1 is sectioned in a lattice shape having width W1 and height H1 and divided into h×w regions on the display surface 61 to create the divided image input data for left eye Da1(1), Da1(2), and Da1(3) to Da1(h×w). Similarly, the image input data for right eye Db1 is sectioned in a lattice shape having width W1 and height H1 to create the divided image input data for right eye Db1(1), Db1(2), and Db1(3) to Db1(h×w).

At the region-parallax calculating step ST1b, the parallax data T11(1) of the first region is calculated with respect to the image input data for left eye Da1(1) and the image input data for right eye Db1(1) for the first region using the Phase-only correlation. Specifically, n at which the phase limiting correlation G_{ab}(n) is the maximum is calculated with respect to the image input data for left eye Da1(1) and the image input data for right eye Db1(1), and is set as the region parallax data T11(1). The region parallax data T11(2) to T11(h×w) are calculated with respect to the image input data for left eyes Da1(2) to Da1(h×w) and the image input data for right eye Db1(2) to Db(h×w) for the second to h×w-th regions using the Phase-only correlation. This operation is equivalent to the operation by the block-parallax calculating unit 11 in the first embodiment.

At the frame-parallax calculating step ST12, maximum parallax data among the region parallax data T11(1) to T11(h×w) is selected and set as the frame parallax data T12. This operation is equivalent to the operation by the frame-parallax calculating unit 12 in the first embodiment.

At the frame-parallax correcting step ST13, processing explained below is applied to the frame parallax data T12.

At frame-parallax buffer step ST3a, the temporally changing frame parallax data T12 is sequentially stored in a buffer storage device having a fixed capacity.

At the frame-parallax arithmetic mean step ST3b, an arithmetic mean of the frame parallax data T12 for previous and subsequent frames of a frame of attention is calculated based on the frame parallax data T12 stored in the buffer region, and the frame parallax data after correction T13 is calculated. This operation is equivalent to the operation by the frame-parallax correcting unit 13 in the first embodiment.

At the frame-parallax-adjustment-amount calculating step ST14, based on the parallax adjustment coefficient S1a and the parallax adjustment threshold S1b set in advance by the viewer 9, the frame parallax adjustment data T14 is calculated from the frame parallax data after correction T13. At a time when the frame parallax data after correction T13 is equal to or smaller than the parallax adjustment threshold S1b, the frame parallax adjustment data T14 is set to 0. Conversely, at a time when the frame parallax data after correction T13 exceeds the parallax adjustment threshold S1b, a value obtained by multiplying S1a with an excess amount of the frame parallax data after correction T13 over the parallax adjustment threshold S1b is set as the frame parallax adjustment data T14. This operation is equivalent to the operation by the frame-parallax-adjustment-amount calculating unit 14 in the first embodiment. For convenience of explanation, concerning the calculation of the frame parallax adjustment data T14, the time when the frame parallax data after correction T13 is equal to or smaller than the parallax adjustment threshold S1b and the time when the frame parallax data after correction T13 exceeds the parallax adjustment threshold S1b are used. Alternatively, a time when the frame parallax data after correction T13 is smaller than the parallax adjustment threshold S1b and a time when the frame parallax data after correction T13 is equal to or larger than the parallax adjustment threshold S1b can be used. In this case, the same effect can be obtained.

An adjusting operation for a pixel parallax is carried out in parallel to the operations at ST11 to ST14. At the block-parallax calculating step ST11, a parallax amount in each of the divided regions is calculated. On the contrary, at the pixel-parallax calculating step ST21, a parallax in each of pixels is calculated based on the image input data for left eye Da1 and the image input data for right eye Db1, and the pixel parallax data T21 is input to the pixel-parallax-adjustment-amount calculating unit 24. The operation at the pixel-parallax calculating step ST21 is equivalent to the operation by the pixel-parallax calculating unit 21 in the first embodiment.

At the pixel-parallax-adjustment-amount calculating step ST24, the pixel parallax adjustment data T24 calculated based on the pixel parallax data T21 output at the pixel-parallax calculating step ST21 and the parallax adjustment information S2 input in advance by the viewer 9 is output. The operation at the pixel-parallax-adjustment-amount calculating step ST24 is equivalent to the operation by the pixel-parallax-adjustment-amount calculating unit 24 in the first embodiment.

In the adjusted-image generating step ST3, after a parallax in each of pixels of the image input data for left eye Da1 and the image input data for right eye Db1 is adjusted based on the pixel parallax adjustment data T24 output at the pixel-parallax-adjustment-amount calculating step ST24, the image input data for left eye Da1 and the image input data for right eye Db1 are adjusted based on the frame parallax adjustment data T14 output at the frame-parallax-adjustment-amount calculating step ST14. As a result, at the adjusted-image generating step ST3, the image output data for left eye Da2 and the image output data for right eye Db2 are output. This operation is equivalent to the operation by the adjusted-image generating unit 3 in the first embodiment.

The operation of the three-dimensional image processing method according to the second embodiment of the present invention is explained above.

According to the above explanation, the image processing method according to the second embodiment of the present invention includes functions equivalent to those of the image processing apparatus 100 according to the first embodiment of the present invention. Therefore, the image processing method according to the second embodiment has effects same as those of the image processing apparatus 100 according to the first embodiment.

According to the present invention, it is possible to suppress occurrence of noise involved in adjustment of a parallax amount and display a three-dimensional image in a range of a depth amount in which an viewer can easily obtain a three-dimensional view.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a frame-parallax-adjustment-amount generating unit that outputs, as first parallax data, parallax data of an image portion protruded most among image portions protruded more than a first reference value from a pair of image input data forming a three-dimensional image;
a pixel-parallax-adjustment-amount generating unit that outputs, as second parallax data, parallax data of an image portion retracted more than a second reference value from the pair of input image data; and
an adjusted-image generating unit that generates a pair of image output data by moving the entire pair of image input data to an inner side based on the first parallax data and moving the image portion retracted more than the second reference value of the pair of image input data to a front side based on the second parallax data to adjust a parallax amount and outputs the pair of image output data.

2. The image processing apparatus according to claim 1, wherein the adjusted-image generating unit subtracts a value, which is based on a difference between the first parallax data and the first reference value, from parallax data of the pair of image input data.

3. The image processing apparatus according to claim 1, wherein the adjusted-image generating unit adds a value, which is based on a difference between the second parallax data of the retracted image portion and the second reference value, to parallax data of the retracted image portion.

4. The image processing apparatus according to claim 1, wherein the first parallax data is calculated based on parallax data of regions formed by dividing the pair of image input data into a plurality of regions.

5. The image processing apparatus according to claim 1, wherein the first parallax data of one frame is corrected based on the first parallax data of other frames to obtain first parallax data after correction.

6. The image processing apparatus according to claim 5, wherein the first parallax data after correction is an average of the first parallax data of the one frame and the first parallax data of previous and subsequent frames of the one frame.

7. An image display apparatus comprising:
an image processing apparatus comprising:
a frame-parallax-adjustment-amount generating unit that outputs, as first parallax data, parallax data of an image portion protruded most among image portions protruded more than a first reference value from a pair of image input data forming a three-dimensional image;
a pixel-parallax-adjustment-amount generating unit that outputs, as second parallax data, parallax data of an image portion retracted more than a second reference value from the pair of input image data; and
an adjusted-image generating unit that generates a pair of image output data by moving the entire pair of image input data to an inner side based on the first parallax data and moving the image portion retracted more than the second reference value of the pair of image input data to a front side based on the second parallax data to adjust a parallax amount and outputs the pair of image output data; and
a display unit, wherein
the display unit displays a pair of image output data generated by the adjusted-image generating unit.

8. An image processing method comprising:
receiving input of a pair of images forming a three-dimensional video and outputting, as first parallax data, parallax data of data of an image portion protruded most among data of image portions protruded more than a first reference value from the pair of image input data;
outputting, as second parallax data, parallax data of data of an image portion retracted more than a second reference value from the pair of input image data; and
generating image output data by moving data of the entire pair of image input data to an inner side based on the first parallax data and moving data of the image portion retracted more than the second reference value of the pair of image input data to a front side based on the second parallax data and outputting the image output data.

9. The image processing method according to claim 8, wherein
the outputting the parallax data as the first parallax data includes:
receiving input of a pair of image input data forming a three-dimensional video, calculating parallax amounts of regions formed by dividing the pair of image input data into a plurality of regions, and outputting the parallax amounts as block parallax data;
outputting frame parallax data based on the block parallax data;
outputting frame parallax data of one frame as frame parallax data after correction, which is obtained by correcting the frame parallax data of the one frame with frame parallax data of other frames; and
outputting frame parallax adjustment data as the first parallax data based on parallax adjustment information, which is created based on information indicating a state of viewing, and the frame parallax data after correction, and
the outputting the parallax data as the second parallax data includes:
detecting a parallax for each of pixels of the pair of image input data and outputting pixel parallax data; and
outputting image parallax adjustment data as the second parallax data based on the parallax adjustment information and the pixel parallax data.
